(19) United States
(12) Patent Application Publication
(10) Pub. No.: US 2025/0124126 A1
(43) Pub. Date: Apr. 17, 2025

(54) UNIFIED IDENTITY PLATFORM

(71) Applicant: Early Warning Services, LLC, Scottsdale, AZ (US)

(72) Inventors: Dan Hayden, Corinth, TX (US); Andrea Motto, San Francisco, CA (US)

(21) Appl. No.: 18/485,130

(22) Filed: Oct. 11, 2023

(51) Int. Cl. G06F 21/55

(52) U.S. Cl. CPC G06F 21/554; G06F 2221/034

(57) ABSTRACT

A method, using one or more processors, comprising receiving a first account identifier associated with a user of electronic data, determining a likelihood of fraudulent activity associated with the user based on the electronic data, determining an institution identifier associated with the user based on the first account identifier and at least in part on the likelihood of fraudulent activity, encrypting the institution identifier to an encrypted institution identifier and the first account identifier to an encrypted first account identifier, communicating, via a secure communications network, at least one of the encrypted institution identifier or the encrypted first account identifier to an account database, receiving, from the account database, noteworthy data associated with the user, determining a second account identifier based on the noteworthy data, and performing a responsive action based on the noteworthy data.

### BACKGROUND OF THE INVENTION

Transmission of sensitive data is becoming an increasingly common part of electronic technology usage. With this popularity, comes a greater risk that this sensitive data is misused (e.g., for fraudulent activity). As such, minimizing fraud by improving data security is a great concern. Accordingly, a need exists for improved methods of fraud prevention.

### BRIEF SUMMARY OF THE APPLICATION

One aspect of the disclosure provides for a method, using one or more processors, comprising receiving a first account identifier associated with a user of electronic data, determining a likelihood of fraudulent activity associated with the user based on the electronic data, determining an institution identifier associated with the user based on the first account identifier and at least in part on the likelihood of fraudulent activity, encrypting the institution identifier to an encrypted institution identifier and the first account identifier to an encrypted first account identifier, communicating, via a secure communications network, at least one of the encrypted institution identifier or the encrypted first account identifier to an account database, receiving, from the account database, noteworthy data associated with the user, determining a second account identifier based on the noteworthy data, and performing a responsive action based on the noteworthy data.

Another aspect of the disclosure provides for a method, using one or more processors, comprising receiving a notification that a first entity was involved in a noteworthy transaction. The notification includes a first account identifier associated with the first entity. The method further includes determining an institution identifier associated with the first entity based on the first account identifier and sending a request to an account database for noteworthy data associated with the first entity. The noteworthy data includes at least one of identifying data or institution system data associated with at least one of the first account identifier or the institution identifier. The method further includes receiving the noteworthy data from the account database and executing a responsive action based on the received noteworthy data. The method may further comprise, prior to sending the request, encrypting the request. The method may further comprise registering the first entity and receiving the institution identifier during registration. Registering the first entity may include creating the account identifier associated with the first entity. Registering the first entity may include sending a second request to the first entity for consent to receive and send data regarding the first entity. The method may further comprise determining a unified identity of the first entity by comparing the noteworthy data with stored identifying data or institution system data. Sending the request may include sending the request for at least one of a stored account identifier or stored institution identifier stored by the account database. The responsive action may include at least one of freezing an account associated with the noteworthy data, banning the account, or cancelling account. The responsive action may include notifying other institution systems in the institution system data of details regarding the first entity. The method may further comprise identifying that the noteworthy transaction may be a fraudulent transaction. The method may further comprise analyzing stored data to determine whether the institution identifier may be associated with an institution account associated with a registered institution system. Sending the request may be based on whether the institution identifier may be determined to be associated with the institution account.

Another aspect of the disclosure provides for a system, comprising one or more computing devices and memory storing instructions. The instructions are executable by the one or more computing devices. The one or more computing devices are configured to receive a notification that a first entity was involved in a noteworthy transaction. The notification includes a first account identifier associated with the first entity. The computing devices are further configured to determine an institution identifier associated with the first entity based on the first account identifier and send a request to an account database for noteworthy data associated with the first entity. The noteworthy data includes at least one of identifying data or institution system data associated with at least one of the first account identifier or the institution identifier. The computing devices are further configured to receive the noteworthy data from the account database and execute a responsive action based on the received noteworthy data. The system may further comprise, prior to sending the request, encrypting the request. The system may further comprise registering the first entity and receiving the institution identifier during registration. Registering the first entity may include creating the account identifier associated with the first entity. Registering the first entity may include sending a second request to the first entity for consent to receive and send data regarding the first entity. The system may further comprise determining a unified identity of the first entity by comparing the noteworthy data with stored identifying data or institution system data. The system may further comprise sending the request may include sending the request for at least one of a stored account identifier or stored institution identifier stored by the account database. The responsive action may include at least one of freezing an account associated with the noteworthy data, banning the account, or cancelling account. The responsive action may include notifying other institution systems in the institution system data of details regarding the first entity. The system may further comprise identifying that the noteworthy transaction may be a fraudulent transaction.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 depicts an example unified identity system according to one aspect of the disclosure.

FIG. 2 depicts an example swimlane diagram depicting a method of unifying identities for an entity according to one aspect of the disclosure.

FIG. 3 depicts an example flowchart unifying identities associated with the unifying identity system 100 according to one aspect of the disclosure.

FIG. 4 depicts a block diagram of an example computer system usable with systems and methods according to one aspect of the disclosure.

### DETAILED DESCRIPTION OF THE INVENTION

Developing electronic technologies require greater and greater amounts of data transmission. Such data transmission comes with increasing security risks, especially where the data being transmitted is sensitive (e.g., data regarding financial information, health information, or the like). This has led to a rise in the prevalence of misuse of data. For example, data may be acquired through unsecured transmissions and used for fraudulent activity (e.g., through scamming or fraudulently altered). As such, these developing technologies create a problem of securing sensitive data transmitted using such electronic means.

One example of data transmission may arise in peer-to-peer (P2P) payment systems. P2P payment systems allow for parties in a transaction to digitally exchange funds with each other. Specifically, a first party may register with a P2P payment system by associating a first financial institution (e.g., a bank, credit union, lender, insurance company, mortgage company, or the like) with the first party. This first party may send funds drawn from that first financial institution to a second financial institution associated with a second party on the P2P payment system. Given the convenience of such fund transfers and the increasing emphasis on digital payments, P2P payment systems are frequently used in modern commercial transactions.

However, with this growing popularity, more and more malicious actors (e.g., fraudsters, thieves, criminals, or the like) are attempting to use these P2P payment systems for fraudulent activity, such as attempting to commit scams using the P2P payment systems. For example, a first party may scam a second party by tricking the second party to send funds to the first party (e.g., by promising to deliver goods or services but never actually delivering on their promise). Such fraudulent activity can have a huge financial impact on the victims of the scams using the P2P payment system, leading to huge and impactful financial losses. Moreover, such fraudulent activity may have a large financial impact on entities that insure transactions against fraudulent activity (e.g., the entity that operates the P2P payment system) as such entities may be required to pay back the funds that were lost due to the fraudulent activity in the transaction. Accordingly, preventing fraudulent activity is important to establish customer trust and minimize financial loss.

Once fraudulent activity is detected, a computer system may flag the malicious actors that were associated with the fraud so that those malicious actors may be dealt with (e.g., banning the bad actor from using the P2P payment systems, reporting the malicious actors to the police, notifying other parties that have transacted with the malicious actors, or the like). However, these malicious actors might register a new account with the P2P payment system knowing that the account they used previously may be flagged. These malicious actors may use this new account to avoid the consequences of the previous account and again commit fraudulent activity with the new account. This repeated process of creating new accounts once a previous account has been used to commit fraud poses a large and growing problem suffered by P2P payment systems in attempting to minimize fraud.

The methods of the present disclosure address this issue by providing a unified identity system that flags all the other accounts associated with the malicious actor once the malicious actor is initially flagged for being associated with fraudulent activity. Accordingly, any attempts by the bad actor to register with the P2P payment service using those other accounts may be blocked, monitored, or otherwise handled. In this manner, conducting transactions using the P2P payment service and unified identity system may be more secure and fraudulent activity may be minimized.

Other examples of data transmission may arise in account creation systems and account registration systems. Such data transmission generally involves non-fraudulent data transmission, however in certain instances, fraudulent activity may be involved in such data transmission as well. Account creation systems and account registration systems enable parties to digitally exchange data and identifying information with each other to create and/or register an account. Specifically, a first party may create a new account, by exchanging data with a second party (e.g., a bank, credit union, lender, insurance company, mortgage company, or the like) to instruct the second party to create or open the new account. The first party may additionally or alternatively register an account by exchanging data with the second party to instruct the second party to register the new or existing account. Given the convenience of such digital account management, data transmission between parties is frequently used in modern account creation and/or account registration transactions.

The methods of the present disclosure assist in account creation and/or account registration transactions by providing the unified identity system that may link, flag, or otherwise identify other accounts associated with the first party after the party has initiated creation and/or registration of an account. Accordingly, the unified identity system can assist both the first and second party during the account creation and/or registration process. In this manner, creating and/or registering accounts with the unified identity system may be quicker, more secure, and fraudulent activity may be minimized.

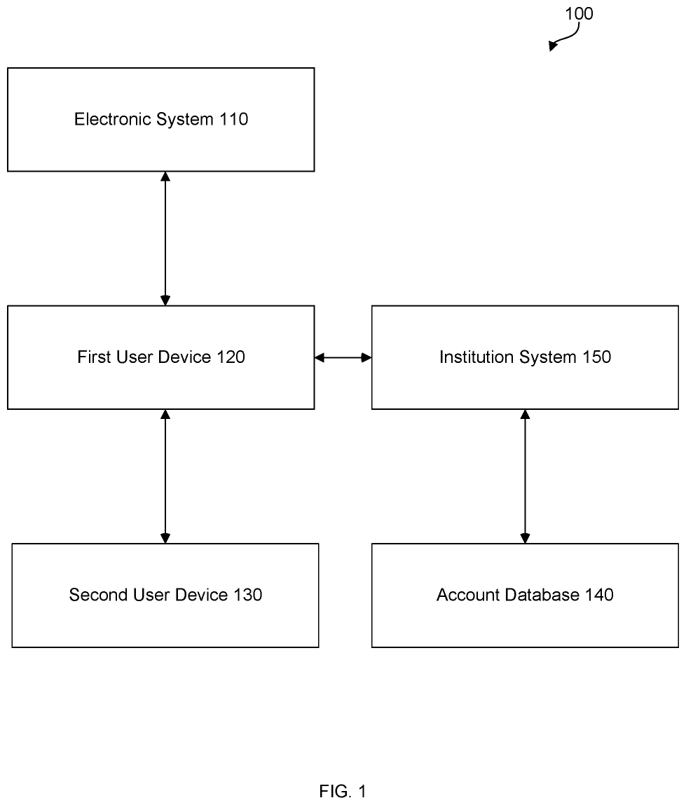

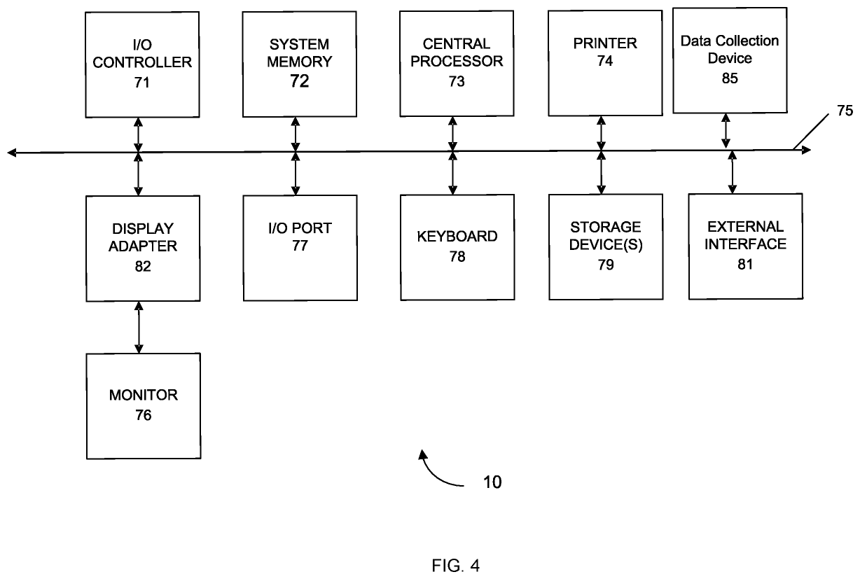

FIG. 1 depicts an example unified identity system 100. The unified identity system 100 may include an electronic system 110, first user device 120, second user device 130, account database 140, and institution system 150. Each of these entities may be in communication (e.g., wireless communication, such as internet communication, Bluetooth™, or the like) with each other. It is understood that, in other embodiments, there may be more or less entities in use with the unified identity system 100. Each of the electronic system 110, first user device 120, second user device 130, account database 140, and institution system 150 may be a network of one or more computers, such as computing system 10 shown in FIG. 4, as described below. The user devices 120, 130 may be one or more computing devices used by entities as a part of a commercial transaction. The account database 140 may store data regarding one or more institution systems associated with various entities and/or user devices, such as all the institution systems (e.g., all the financial institutions) associated with the entity using the first user device 120. The institution system 150 may be a financial institution associated with an entity, such as the entity of the first user device 120. The electronic system 110 may be a computing system that facilitates the transfer of funds between institution systems of user devices 120, 130, such as a P2P payment system. In other embodiments, the electronic system 110 may be a computing system that verifies user identities (e.g., verifying user accounts of other computing systems), financial verification (e.g., check verification), or the like. For example, the electronic system 110 may facilitate the transfer of funds between the first user device 120 and the second user device 130 as a part of a commercial transaction between the user devices 120, 130.

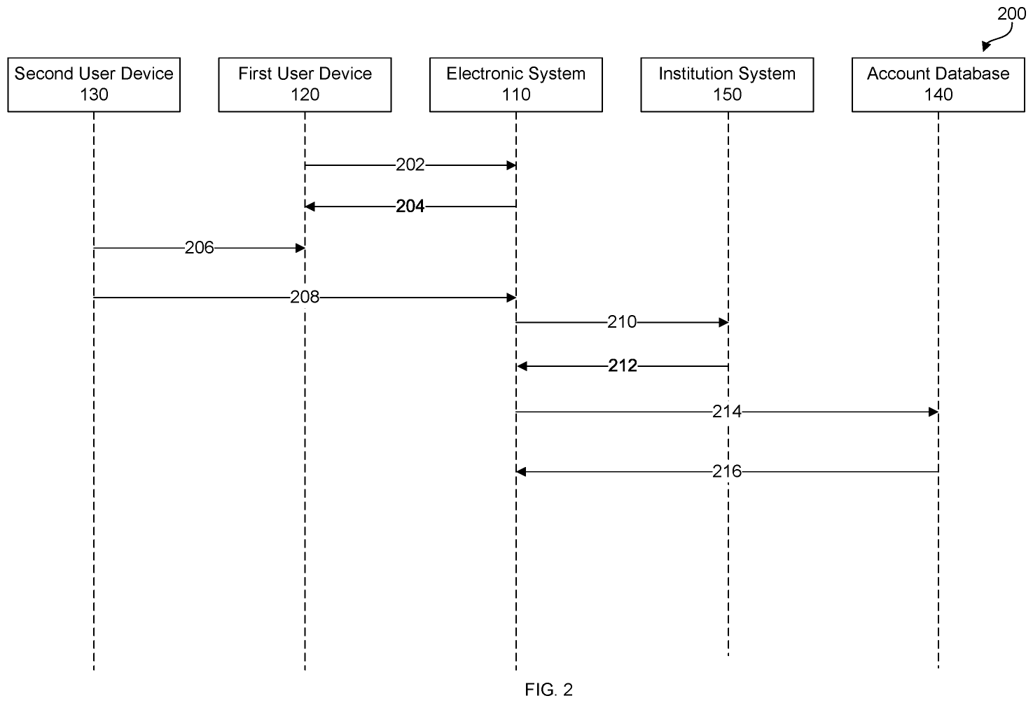

FIG. 2 depicts an example swimlane diagram 200 of unifying identities associated with the unifying identity system 100. As will be discussed in greater detail, the swimlane diagram 200 depicts a method of determining other institution systems (e.g., financial institutions) associated with an entity based on the entity's use of a first institution system of a noteworthy transaction (or interaction). For example, a noteworthy transaction can be a fraudulent or good transaction. As noted above, this can be helpful to prevent further fraud from being committed by a fraudulent entity by taking responsive actions to prevent the fraudulent entity from using their other institution systems to commit further fraud.

Turning to step 202, a first user device 120 initiates a registration process with the electronic system 110 to create a user account. Specifically, the entity may visit a website/mobile application of the electronic system 110 and may enter identifying data to register with the electronic system 110. The data may include personally identifiable information (PII) of the entity. PII data can include address information, names, birth dates, social security numbers, income levels of each person at the address, occupations, household size, or the like. Where an address is associated with a business or a corporate entity, PII may additionally include information regarding that business or corporation (e.g., a company's principal place of business, corporate officers, state of incorporation, or the like). Addresses can be standardized by the computer system for accommodating slight variations between addresses. As an example, abbreviations may be standardized and/or expanded such that different formats for the same address may be identified and grouped together. In some embodiments, the entity may register with authentication data to authenticate the entity's identity later on. Examples of authentication data may include one or more biometrics, such as facial recognition or finger print, a personal identification number, other devices of the entity capable of verifying the entity's identity, or the like.

As a part of this registration process, the entity may associate the institution system 150 with the user account so that the user account may use this institution system 150 for future transactions. For example, the entity may associate the entity's bank with the user account by registering, with the electronic system 110, an institution account (e.g., bank account, savings account, checking account, credit card, retirement account, or the like) the entity already has with the bank. In this manner, the electronic system 110 can withdraw funds from, or deposit funds to, the institution system 150. In the process of associating the institution system 150 with the entity, the institution system 150 may provide one or both of the first user device 120 and the electronic system 110 an institution identifier. As will be discussed further below, this identifier can be later used to access data stored by the institution system 150 associated with the entity of the first user device 120. The electronic system 110 can create an account identifier associated with the user account, which may be later used to access one or more of the encrypted identifying data, authentication data, and institution system data (e.g., data regarding financial institutions) of the user account stored by the electronic system 110. The electronic system 110 may store the entity's identifying data, authentication data, and institution system data for later use, as will be discussed further below. The institution system data may include the name of the institution system 150 associated with a user account, the institution identifier, and account information of an institution account that is registered with the institution system 150 (e.g., the account number, banking number, routing number, credit card number, or the like). A more detailed discussion of the account registration process and registering an institution system to a user account can be found in U.S. patent application Ser. No. 18/095,799, entitled “DATA BROKER,” filed Jan. 11, 2023, the disclosure of which is incorporated by reference herein in its entirety.

As a part of this registration process, because the data contains sensitive information, the electronic system 110 can encrypt the data provided by the first user device 120 (e.g., the identifying data, authentication data, and institution system data). This may include converting the data into a ciphertext with an encryption algorithm that can be unlocked and accessed once a corresponding identifier is presented. Encryption algorithms may include a Triple Data Encryption Standard (DES) algorithm, Advanced Encryption Standard (AES) algorithm, Rivest-Shamir-Adleman (RA) algorithm, Blowfish algorithm, Twofish algorithm, or the like. An identifier may be an alphanumeric code that can, itself, be encrypted and decrypted using various cryptographic methods to access databases or tables that are assigned to specific entities. This ciphertext may be unreadable and unusable to anyone without the identifier to decrypt the data. For example, the identifier may be provided to a database to gain access to sensitive data of an entity, such as identifying data, authentication data, and institution system data associated with the entity. It should be understood that any transmission or storage of data noted in this disclosure can include encryption.

Without encryption, the data stored by the electronic system 110 is open to a wide range of threats. For example, sensitive data can be more easily accessed by malicious actors for misuse, which can lead to identity theft, fraud, or the like. In particular, malicious actors may access the user account with the electronic system 110 to conduct unauthorized transactions, extort the entity of the first user device 120, or sell the information of the user account. The entity that owns the electronic system 110 may additionally be susceptible to legal issues as there may be laws requiring a minimum level of data security for the data stored and transmitted by the electronic system 110. The data may also be susceptible to being manipulated without any encryption protecting the data from unwanted access.

The encryption process of the electronic system 110 can address these issues. First and foremost, encrypting the data can help ensure that the data is secured so that malicious actors cannot access the sensitive information. This prevents those malicious actors from using the data for misuse. This may be especially helpful for transactions conducted over unsecure networks, such as with public WiFi™ or without a virtual private network, as transactions over such networks may be particularly susceptible to unwanted access. In some embodiments, the electronic system 110 can send the encrypted data over a secure communications network (e.g., a private WiFi™ or with a virtual private network) Further, such encryption can ensure that the electronic system 110 complies with various laws that mandate such data maintains a minimum level of security, which may be especially important for entities dealing with funds. Encryption additionally can ensure that the data being transmitted or stored is not tampered with or altered by anyone without the appropriate identifier. Any transmission of data and identifiers between entities noted in the instant disclosure can be encrypted or provided in an encrypted communication by the electronic system 110.

Additionally, as a part of this registration process, the electronic system 110 may send a request to the first user device 120 requesting for consent to access data associated with the entity of the first user device 120. For example, the electronic system 110 may request consent to access data associated with other institution systems associated with the entity of the first user device 120 (e.g., once the appropriate institution identifier is presented to the institution system). In some embodiments, the electronic system 110 may proceed with the registration process only if consent is received for this data. The consent request may additionally include a request for consent for the electronic system 110 to receive and send data regarding the entity of the first user device 120, as well as information regarding the first user device 120 itself, with other entities, such as the second user device 130, the institution system 150, and/or the account database 140.

Turning to step 204, the electronic system 110 can register the entity with a user account and provide the account identifier to the first user device 120. Accordingly, whenever the first user device 120 uses the electronic system 110 for any transaction (e.g., to transfer or withdraw funds using the institution system 150 associated with the user account), the account identifier may be automatically associated with that transaction so that the electronic system 110 can later determine whether the user account was a part of that transaction.

Turning to step 206, the first user device 120 may conduct a transaction with the second user device 130 using the electronic system 110. For example, the second user device 130 may transfer funds to the first user device 120. The second user device 130 may have been previously and independently registered with the electronic system 110, as discussed above with the first user device 120. The transaction between the user devices 120, 130 may be a noteworthy transaction involving a noteworthy actor. For example, the transaction may be a fraudulent transaction where one of the user devices 120, 130 engaged in one or more dishonest transactions with the other user device 120, 130 (e.g., the first user device 120 receives payment from the second user device 130 without providing a promised good or service to the second user device 130). In this example, the entity of the first user device 120 may be identified as a malicious actor. In another example of a fraudulent transaction, the second user device 130 may provide funds to the first user device 120 as a part of a fraudulent transaction. In this example, the second user device 130 may be identified as a malicious actor. In another example, the noteworthy transaction may be a good transaction. For example, the first user device 120 may provide an additional good or service to the second user device 130 (or to another entity as a donation or gift, such as a donation to a charitable organization) in addition to what the first user device 120 promised to deliver to the second user device 130. In this example, the first user device 120 may be identified as a good actor.

Turning to step 208, the second user device 130 may notify the electronic system 110 that the transaction between the user devices 120, 130 was noteworthy (e.g., fraudulent or good) and that the user registered with the first user device 120 is a noteworthy entity. For example, the second user device 130 may notify the electronic system 110 that the transaction between the user devices 120, 130 was fraudulent and that the first user device 120 is associated with a fraudulent entity. However, in other embodiments, the first user device may notify the electronic system that the transaction was good, and not a fraudulent transaction. For example, the entity of the first user device may notify the electronic system that proper payment was received from the entity of the second user device. In other embodiments, the electronic system 110 may be monitoring transactions that use the electronic system (e.g., P2P transactions, account creation transactions, and account registration transactions) in real-time. As the electronic system is monitoring the transactions, the electronic system may identify noteworthy transactions.

The electronic system 110 may review the transaction between the user devices 120, 130 to verify whether the transaction was noteworthy and whether the first user device 120 is a noteworthy actor (e.g., by reviewing the evidence of fraud as submitted by the second user device 130). For example, the electronic system may determine that the transaction is fraudulent. The electronic system may use a risk model trained using machine learning techniques to determine the likelihood that a given transaction is fraudulent. The risk model may be trained using the techniques as described in U.S. patent application Ser. No. 17/842,688 by Hayden et al, entitled “FRAUD DETECTION SYSTEMS AND METHODS,” filed May 25, 2022, the disclosure of which is incorporated by reference herein its entirety. In some embodiments, the electronic system 110 may not continue further with the steps of the disclosed method unless the likelihood of fraud is greater than a threshold value. In other embodiments, the electronic system may not determine that the transaction was noteworthy (e.g., fraudulent or good) but, instead, automatically review the identifying and institution system data of the noteworthy entity to expedite the process of determining other institution systems associated with the entity. This may be particularly helpful to prevent additional fraud by more quickly being able to conduct a responsive action to stop the noteworthy entity from using other financial accounts to commit fraud.

Next, the electronic system 110 may identify an account identifier associated with the user account of the noteworthy entity used by the first user device 120 during the transaction. With the account identifier, the electronic system 110 may access and review the identifying data and the institution system data of the user account associated with the first user device 120. For example, the electronic system 110 may utilize the account identifier associated with the user account used by the first user device 120 to search the stored account identifiers of all users that have registered a user account with the electronic system 110 to find the user account used by the noteworthy entity during the transaction. Once this user account is identified, the electronic system 110 may determine an institution identifier and institution system data associated with the user account by identifying the institution identifier associated with the user account when the noteworthy entity registered the financial institution 150 with the electronic system 110. Note that, in some embodiments, the user account may have multiple institution identifiers corresponding to multiple financial institutions registered with the user account. In this manner, the electronic system 110 can determine the institution system 150 associated with the user account used by the noteworthy entity during the transaction. In some embodiments, the electronic system can utilize the identified user account to determine the institution identifier and institution system data in real-time. In other embodiments, the electronic system is programmed to execute on a schedule (e.g., every hour, every 8 hours, every 12 hours, etc.) to determine the institution identifier and institution system data associated with the identified user account.

Turning to step 210, the electronic system 110 may request the institution system 150 for a confirmation that the institution identifier associated with the user account of the noteworthy entity of the first user device 120 identifies, or is otherwise associated with, an institution account that is registered with the institution system 150. The institution system 150 may check that the institution identifier corresponds with an institution account registered with the institution system 150 (e.g., a bank account associated with the institution system 150). Turning to step 212, the institution system 150 may provide a confirmation that the institution identifier corresponds to an institution account registered with the institution system 150 if the institution system 150 finds a registered institution account. Conversely, the institution system 150 may provide a confirmation that there is no institution account associated with the institution identifier if the institution system 150 does not find an institution account registered with the institution system 150 that is associated with the institution identifier.

In some embodiments, the request may include the identifying data associated with the entity of the first user device 120. The institution system 150 may use this identifying data to confirm that the institution account registered with the institution system 150 corresponds to the noteworthy entity associated with the institution identifier. Specifically, after the institution system 150 identifies an account associated with the institution identifier, the institution system 150 may check whether the identifying data corresponds to the data stored by the institution system 150 for the institution account. For example, the institution system 150 may check whether the identifying data associated with the institution account share matching names, addresses, birthdays, or any other identifying data. This may be beneficial to avoid instances where the noteworthy entity may have stolen and used an institution account of someone else when the noteworthy entity initially registered the user account with the institution system 150 during registration with the electronic system 110.

In other embodiments, rather than requesting confirmation from the institution system, the electronic system may analyze data previously received from the institution system (e.g., institution system data provided by the institution and identifying data provided by the noteworthy entity during the initial registration of the user account) for confirmation that the institution identifier associated with the user account of the noteworthy entity identifies, or is otherwise associated with, an institution account that is registered with the institution system. Specifically, the electronic system may check stored data regarding whether the institution identifier corresponds with an institution account registered with the institution system in a similar manner as the institution system as described above. For example, the electronic system may confirm that the institution identifier corresponds to an institution account registered with the institution system if the electronic system finds a registered institution account in the stored data. Conversely, the electronic system may provide a confirmation that there is no institution account associated with the institution identifier if electronic system does not find an institution account registered with the institution system that is associated with the institution identifier.

Turning to step 214, the electronic system 110 may request the account database 140 for stored account identifiers, institution identifiers, identifying data, and/or institution system data of other institution systems associated with the noteworthy entity of the first user device 120. The request may include at least one of the account identifier and/or institution identifier associated with the noteworthy entity of the first user device 120, and/or the identifying data associated with the account identifier and the institution system data of the institution account associated with the institution identifier and the noteworthy entity. Once the request is received, the account database 140 may cross-reference at least one of the provided account identifier, institution identifier, the identifying data, and/or the institution system data against the data stored by the account database 140 (e.g., the stored account identifier, institution identifier, the identifying data, and/or the institution system data of entities stored by the account database 140) to see if the provided account identifier, institution identifier, identifying data, and/or the institution system data is associated with any corresponding institution accounts or identifying data of entities stored by the account database 140.

If the account database 140 did not find identifying data or institution accounts associated with the account identifier, institution identifier, identifying data and/or institution system data provided by the electronic system 110, the account database 140 may respond to the electronic system 110 that the account database 140 did not find any identifying data or institution accounts associated with the account identifier, institution identifier, identifying data and/or the institution system data provided in the request. If the account database 140 finds identifying data or institution account associated with the account identifier, institution identifier, identifying data, and/or the institution system data provided by the electronic system 110, the account database 140 may capture, record, and/or flag all the identifying data and/or institution accounts associated with the provided data. Specifically, the account database 140 may capture, record, and/or flag all the identifying data (e.g., PII data including, but not limited to, the name, address, phone number, email, or the like) associated with the provided institution identifier and/or institution system data, as well as institution system data (e.g., bank account number, credit card number, or the like) for each identified institution account, as a part of noteworthy data associated with the noteworthy entity. Further, the institution system data may include one or more other institution identifiers of other institution accounts (e.g., with the institution system 150 or with other institutions systems) associated with the noteworthy entity. In some embodiments, the electronic system may send a first request for identifying data associated with the provided institution identifier and/or the institution system data and then a second request for the institution system data of other institution accounts associated with the provided institution identifier and/or the institution system data using the received identifying data.

In other embodiments, the electronic system may directly request the account database for institution system data without communicating with the institution system that is associated with the user. For example, the electronic system may directly send the request to the account database without requesting confirmation from the institution system that the institution identifier is associated with an institution account registered with the institution system. Accordingly, the electronic system may receive data regarding institution systems associated with the entity of the first user device without needing to contact the institution system, thus expediting the process of acquiring more data regarding the noteworthy entity.

Turning to step 216, the account database 140 may provide the noteworthy data (e.g., all identifying data, institution system data, and/or institution identifiers that the account database 140 flagged as being associated with the noteworthy entity) to the electronic system 110. The electronic system 110 may store this noteworthy data.

The electronic system 110 may use the noteworthy data to determine whether other user or institution accounts registered by the noteworthy entity with the electronic system 110 are also associated with the noteworthy data. Specifically, the electronic system 110 may determine whether the noteworthy data includes an account identifier, identity data, and/or institution system data that match other user accounts registered with the electronic system 110. For example, this analysis may include checking whether any institution accounts registered with the electronic system 110 includes identifying data, account data, institution system data and/or institution identifiers of any institution systems associated with the noteworthy data.

If the electronic system 110 identifies any other user or institution accounts registered by the noteworthy entity, the electronic system 110 may capture, record, and/or flag these other user accounts (e.g., flagging these other account identifiers) registered with the electronic system 110 that are associated with one or more of the institution systems associated with the noteworthy data, as well as user accounts that have at least some matching data with the noteworthy data (e.g., greater than or about 25% matching data, greater than or about 50% matching data, greater than or about 75% matching data or about 100% matching data). The electronic system 110 generates a unified identity of the noteworthy entity that is linked to or otherwise associated with all of the user or institution accounts of the noteworthy entity (e.g., as other user or institution accounts registered with the electronic system 110 used by the noteworthy entity). In some embodiments, the electronic system 110 may check whether any of the flagged user accounts have already been previously flagged. If those identified user accounts have been previously flagged, the electronic system 110 may not continue with any further steps of the disclosed method for those previously flagged user accounts. In some embodiments, the electronic system may additionally include in the unified identity the institution accounts that were noted as being associated with the noteworthy entity in the noteworthy data.

In some embodiments, the electronic system 110 may send a request to all the institution systems associated with the flagged institution accounts, or analyze data received from the institution systems, for confirmation that the institution systems have a corresponding institution account associated with flagged institution accounts. The request can include the flagged institution identifiers. Once the electronic system 110 receives confirmation from at least one of the institution systems, the electronic system 110 will move forward with the rest of the disclosed method. However, in other embodiments, the electronic system may continue with the disclosed method without sending a request for confirmation to the institution systems.

When the electronic system 110 analyzes for other user accounts the noteworthy entity may have registered with the electronic system 110, the electronic system 110 may standardize the format of all the data that the electronic system 110 has regarding the noteworthy entity to better identify other user accounts that the noteworthy entity has registered with the electronic system 110. For example, where PII stored in the identifying data includes a name, the name may be broken down into tokens and non-letter characters may be removed. For each name component (e.g., prefix, given name, family name, suffix, etc.) a lookup may be performed to identify if there are one or more standard forms of the given name component. The lookup may return the original name components, any standardized components (linked by original component), abbreviated forms of any names (de-duplicated), encoded forms of names (de-duplicated), concatenated forms of the original name components (e.g., the name of the particular person), a gender estimation based on the original components provided, and/or other information. The electronic system 110 may then determine which user accounts are associated with the noteworthy entity by determining which user accounts have matching data (e.g., identifying data, institution system data, or the like). A greater discussion regarding the standardization and matching process can be found in U.S. patent application Ser. No. 17/842,598 by Hayden et al, entitled “SYSTEMS AND METHODS FOR SYNTHETIC IDENTITY DETECTION,” filed Jun. 16, 2022, the disclosure of which is incorporated by reference herein its entirety.

Once those user and/or institution accounts are flagged (and are identified as not being previously flagged), the electronic system 110 may conduct a responsive action based on the unified identity to prevent more fraud from being committed by the noteworthy entity (e.g., freezing, cancelling, blocking, and/or banning the noteworthy entity from creating more user accounts with the electronic system 110). The electronic system 110 may additionally or alternatively monitor future transactions performed by the user accounts of the unified identity (e.g., user accounts associated with the noteworthy entity). The electronic system 110 may additionally monitor for new user accounts being registered with the electronic system 110 that may share data with the noteworthy data and flag these new user accounts as being associated with the noteworthy entity. The electronic system 110 may additionally notify the noteworthy entity that their user accounts are frozen, canceled, blocked, banned, and/or monitored by sending a message to the first user device 120 (and any other device associated with the other user accounts).

As noted above, determining a unified identity by flagging all the user accounts that are associated with the noteworthy entity of the first user device 120 may assist in minimizing the amount of fraud being committed with the electronic system 110. Previously, the noteworthy entity may use other user accounts registered with the electronic system whenever the electronic system flags one user account of the noteworthy entity as having committed fraud. The method of the instant disclosure addresses this issue by flagging all user accounts registered by the noteworthy entity with the electronic system 110 so that the noteworthy entity may not use those user accounts for further fraudulent activities. The solution provided by this method improves the security offered to the field of electronic systems and, especially, those using P2P electronic systems by decreasing the amount of fraud being committed on these systems.

In other embodiments, the responsive action may additionally or alternatively include notifying the institution systems associated with the flagged institution accounts of the unified identity that the noteworthy entity has committed fraud and/or of the details of the noteworthy transaction. Those institution systems may then freeze, cancel, block, ban, and/or monitor the entity from creating more accounts with the institution systems. This may have the even more beneficial effect of preventing the noteworthy entity from committing further fraud with any other electronic system in addition to the electronic system that the noteworthy entity initially used. In yet other embodiments, if the electronic system notifies the account database of the entity's fraudulent activity, the account database may notify the institution systems regarding the entity's fraudulent activity, rather than the electronic system. In a yet further embodiment, the electronic system may notify a legal entity (e.g., a criminal prosecutor) regarding the fraudulent transaction, and provide the user accounts, institution account and noteworthy data associated with the noteworthy entity.

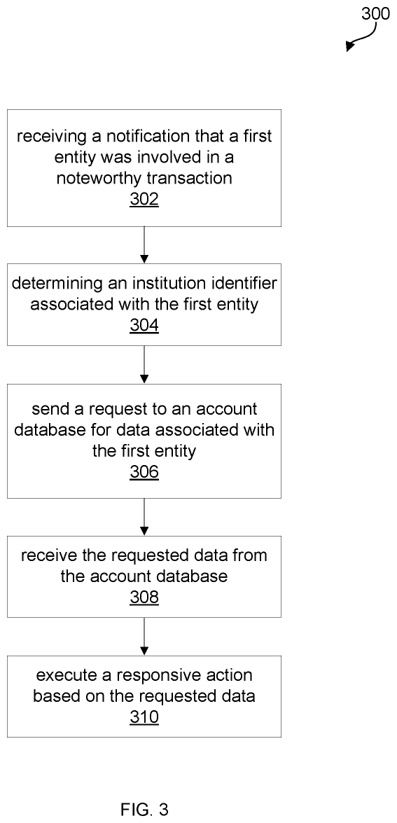

FIG. 3 depicts an example flowchart depicting a method of unifying identities using a computing device, with reference to the unified identity system 100. Turning to step 302, the electronic system 110 may receive a notification that a first entity was involved in a noteworthy transaction. The notification may include first data associated with the first entity. The first data may include the account identifier. For example, the electronic system 110 may receive a notification that the transaction between the first user device 120 and the second user device 130 is noteworthy, similar to step 208. The electronic system 110 may receive this notification after the first user device 120 has registered with the electronic system 110, similar to steps 202 and 204, and the first and second user devices 120, 130 have conducted a transaction, similar to step 206.

Turning to step 304, the electronic system 110 may determine an institution identifier associated with the first entity based on the first account identifier. For example, the electronic system 110 may identify an account identifier and user account registered with the electronic system 110 based on the account identifier. The electronic system 110 may determine an institution identifier associated with this user account using that account identifier. The electronic system 110 may additionally send a request to the institution system 150 for a confirmation that the institution identifier associated with the noteworthy entity is registered with an institution account that is registered with the institution system 150, similar to step 210 and may receive confirmation from the institution system 150, similar to step 212. Alternatively, the electronic system 110 may analyze data provided by the institution system 150 when the user account of the first entity was initially registered with the electronic system to determine whether the institution identifier is associated with the first entity.

Turning to step 306, the electronic system may send a request to an account database for at least one of an account identifier, institution identifier, identifying data or institution system data associated with the institution identifier that is stored by the account database. The request may include the identifying data, account identifier, institution identifier, and/or the institution system data of the institution account associated with the institution identifier and the noteworthy entity that is already registered with the electronic system 110. For example, the electronic system 110 may request the account database 140 for all account identifiers, institution identifiers, identifying data and/or institution systems data (e.g., noteworthy data) associated with the noteworthy entity of the first user device 120 that is stored by the account database 140, similar to step 214. The account database 140 may check the provided account identifiers, institution identifiers, institution identifier and/or institution system data against the data stored by the account database 140 to see if the provided account identifiers, institution identifiers, institution identifier, and/or the institution system data is associated with any entities or institution accounts stored by the account database 140.

Turning to step 308, the electronic system may receive the at least one of identifying data or institution system data from the account database. For example, the electronic system 110 may receive the noteworthy data from the account database 140, similar to step 216. In some embodiments, the electronic system 110 may store this institution system data. The electronic system 110 may determine a unified identity of the noteworthy entity by comparing the noteworthy data provided by the account database 140 with the data stored by the electronic system 110 in order to determine other user or institution accounts registered by the noteworthy entity associated with the electronic system 110 that also correspond with the data provided by the account database 140. This may include standardizing the format of all the data that the electronic system 110 has regarding the noteworthy entity to better identify other user or institution accounts that the noteworthy entity has registered with the electronic system 110. Based on this comparison, the electronic system 110 may capture, record, and/or flag user accounts and/or institution accounts associated with the noteworthy entity as a part of the unified identity of the noteworthy entity.

Turning to step 310, the electronic system may execute a responsive action based on the at least one of identifying data or institution system data. For example, the electronic system 110 may freeze, cancel, block, ban, and/or monitor the noteworthy entity from creating more accounts with the electronic system 110. In other embodiments, the electronic system 110 may additionally or alternatively include notifying other institution systems or legal entities of the details of the noteworthy entity (e.g., that the noteworthy entity has committed fraud) and/or of the noteworthy transaction.

Any of the computer systems mentioned herein may utilize any suitable number of subsystems. Examples of such subsystems are shown in FIG. 4 in computer system 10. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 4 are interconnected via a system bus 75. Additional subsystems such as a printer 74, keyboard 78, storage device(s) 79, monitor 76 (e.g., a display screen, such as an LED), which is coupled to display adapter 82, and others are shown.

Peripherals and input/output (I/O) devices, which couple to I/O controller 71, can be connected to the computer system by any number of means known in the art such as input/output (I/O) port 77 (e.g., USB, FireWire®). For example, I/O port 77 or external interface 81 (e.g., Ethernet, Wi-Fi, etc.) can be used to connect computer system 10 to a wide area network such as the Internet, a mouse input device, or a scanner. The interconnection via system bus 75 allows the central processor 73 to communicate with each subsystem and to control the execution of a plurality of instructions from system memory 72 or the storage device(s) 79 (e.g., a fixed disk, such as a hard drive, or optical disk), as well as the exchange of information between subsystems. The system memory 72 and/or the storage device(s) 79 may embody a computer readable medium. Another subsystem is a data collection device 85, such as a camera, microphone, accelerometer, and the like. Any of the data mentioned herein can be output from one component to another component and can be output to the user.

A computer system can include a plurality of the same components or subsystems, e.g., connected together by external interface 81, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g., an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such devices. In addition, the order of operations may be re-arranged. A process can be terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Any operations performed with a processor may be performed in real-time. The term “real-time” may refer to computing operations or processes that are completed within a certain time constraint. The time constraint may be 1 minute, 1 hour, 1 day, or 7 days. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In some implementations, operations or processing may involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining,” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other data storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A method, using one or more processors, comprising:
receiving a first account identifier associated with a user of electronic data;
determining a likelihood of fraudulent activity associated with the user based on the electronic data;
determining an institution identifier associated with the user based on the first account identifier and at least in part on the likelihood of fraudulent activity;
encrypting the institution identifier to an encrypted institution identifier and the first account identifier to an encrypted first account identifier;
communicating, via a secure communications network, at least one of the encrypted institution identifier or the encrypted first account identifier to an account database;
receiving, from the account database, noteworthy data associated with the user;
determining a second account identifier based on the noteworthy data; and
performing a responsive action based on the noteworthy data.

2. A method, using one or more processors, comprising:
receiving a notification that a first entity was involved in a noteworthy transaction, wherein the notification includes a first account identifier associated with the first entity;
determining an institution identifier associated with the first entity based on the first account identifier;
sending a request to an account database for noteworthy data associated with the first entity, wherein the noteworthy data includes at least one of identifying data or institution system data associated with at least one of the first account identifier or the institution identifier;
receiving the noteworthy data from the account database; and
executing a responsive action based on the received noteworthy data.

3. The method of claim 2, further comprising, prior to sending the request, encrypting the request.

4. The method of claim 2, further comprising:
registering the first entity, wherein registering the first entity includes creating the account identifier associated with the first entity; and
receiving the institution identifier during registration.

5. The method of claim 4, wherein registering the first entity includes sending a second request to the first entity for consent to receive and send data regarding the first entity.

6. The method of claim 2, further comprising determining a unified identity of the first entity by comparing the noteworthy data with stored identifying data or institution system data.

7. The method of claim 2, wherein sending the request includes sending the request for at least one of a stored account identifier or stored institution identifier stored by the account database.

8. The method of claim 2, wherein the responsive action includes at least one of:
freezing an account associated with the noteworthy data;
banning the account; or
cancelling account.

9. The method of claim 2, wherein the responsive action includes notifying other institution systems in the institution system data of details regarding the first entity.

10. The method of claim 2, further comprising identifying that the noteworthy transaction is a fraudulent transaction.

11. The method of claim 2,
further comprising analyzing stored data to determine whether the institution identifier is associated with an institution account associated with a registered institution system,
wherein sending the request is based on whether the institution identifier is determined to be associated with the institution account.

12. A system, comprising:
one or more computing devices; and
memory storing instructions, the instructions being executable by the one or more computing devices, wherein the one or more computing devices are configured to:
receive a notification that a first entity was involved in a noteworthy transaction, wherein the notification includes a first account identifier associated with the first entity;
determine an institution identifier associated with the first entity based on the first account identifier;
send a request to an account database for noteworthy data associated with the first entity, wherein the noteworthy data includes at least one of identifying data or institution system data associated with at least one of the first account identifier or the institution identifier;
receive the noteworthy data from the account database; and
execute a responsive action based on the received noteworthy data.

13. The system of claim 12, further comprising, prior to sending the request, encrypting the request.

14. The system of claim 12, further comprising:
registering the first entity, wherein registering the first entity includes creating the account identifier associated with the first entity; and
receiving the institution identifier during registration.

15. The system of claim 14, wherein registering the first entity includes sending a second request to the first entity for consent to receive and send data regarding the first entity.

16. The system of claim 12, further comprising determining a unified identity of the first entity by comparing the noteworthy data with stored identifying data or institution system data.

17. The system of claim 12, wherein sending the request includes sending the request for at least one of a stored account identifier or stored institution identifier stored by the account database.

18. The system of claim 12, wherein the responsive action includes at least one of:
freezing an account associated with the noteworthy data;
banning the account; or
cancelling account.

19. The system of claim 12, wherein the responsive action includes notifying other institution systems in the institution system data of details regarding the first entity.

20. The system of claim 12, further comprising identifying that the noteworthy transaction is a fraudulent transaction.
